(19) United States
(12) Patent Application Publication
(10) Pub. No.: US 2025/0298160 A1
(43) Pub. Date: Sep. 25, 2025

(54) SELF-ORIENTING SPHERICAL SENSING NODE AND METHOD

(71) Applicant: SERCEL, Carquefou (FR)

(72) Inventors: Daniel ANGEBAUD, Carquefou (FR); Olivier BREGEON, Carquefou (FR)

(21) Appl. No.: 18/614,066

(22) Filed: Mar. 22, 2024

(51) Int. Cl. G01V 1/16

(52) U.S. Cl. CPC G01V 1/162; G01V 1/168

(57) ABSTRACT

A sensing node for sensing a parameter when dropped on the ground, includes an outer shell having a spherical internal cavity, an inner frame configured to hold a sensor and to fully fit inside the spherical internal cavity, and a support mechanism provided between the outer shell and the inner frame and configured to allow the inner frame to freely rotate relative to the outer shell and also configured to prevent the inner frame from directly touching the outer shell when dropped on the ground.

### BACKGROUND

### Technical Field

Embodiments of the subject matter disclosed herein generally relate to systems and methods for acquiring data in the field with one or more sensors having a sensing axis that needs to have a given orientation, and more particularly, to deploying spherical sensing nodes, e.g., seismic nodes, without considering their orientations, as the spherical sensing nodes achieve automatic self-orientation of the sensing axis of their sensors.

### Discussion of the Background

Seismic surveying investigates and maps the structure and character of geological formations underground or under a body of water using reflection seismology. Reflection seismology is a method of geophysical exploration especially helpful in the oil and gas industry, but also deployed for other purposes like geothermal projects, CO₂ storage, windmill installation, structure integrity estimation. In reflection seismology (both onshore and offshore), the depth and the horizontal location of features causing reflections of seismic waves are evaluated by measuring the time it takes for the seismic wave to travel from a source to one or more receivers (e.g., seismic sensors) deployed over the region of interest. These features may be associated with subterranean hydrocarbon reservoirs.

A land seismic surveying system 100, which is illustrated in FIG. 1, uses plural seismic sensing nodes 110 for surveying a large area 120 to explore subsurface resources, like oil, gas, hydrothermal fluids, ore, etc., before drilling wells or other invasive and/or costly acts. System 100 includes hundreds if not thousands of wireless seismic nodes 110, and the nodes are distributed and oriented over the entire area 120 of interest for recording seismic signals. The wireless seismic nodes 110 can be placed according to a given orderly pattern over the area 120, or in any other way. Each seismic node needs to be oriented relative to the gravity so that the sensing axis of its sensor is substantially vertical. This constraint significantly increases the deployment time of the nodes. The wireless seismic nodes 110 may be configured to exchange (non-seismic) data between them, in an ad-hoc network. In one implementation, the wireless seismic nodes 110 communicate with a general controller 130 and can receive instructions or commands from this controller. In some implementations, a harvester 140, having its own antenna 142 and processing capabilities 144, can move about each node and collect the stored seismic data. Each seismic node 110 includes dedicated electronics (microprocessor, storage device, e.g., a memory, transceiver, seismic sensor 114, etc.) that is housed inside the node's housing, and may have an antenna 112, for wireless communication with the harvester 140.

The recording of the seismic signals (or other signals) can be implemented in various ways, for example, in short periods of time repeated over a long period of time, or continuously over a long period of time. Regardless of the method selected for recording the seismic data, the seismic nodes 110 have a limited amount of memory for recording the seismic data, and a limited amount of electrical power for running its internal components and also for communication with other nodes and/or harvester devices and/or with one or more servers. In one embodiment, the seismic nodes 110 are configured to receive GPS signals for providing a time stamp to the recorded data and/or also for obtaining the geographical coordinates of the node.

In addition to the above power constraints, current seismic acquisition campaigns are faced with an increased pressure of reducing the cost of their operations. To achieve this goal, the seismic acquisition campaigns try to reduce their crew or to decrease deployment and retrieving time for the sensors/nodes. The largest time-consuming operation for a land seismic acquisition campaign relates to ensuring good ground coupling between the node and the ground, but also achieving the desired orientation of the sensing axis of the sensors for optimizing the detection of the signals. This is usually achieved by partially or totally burying the seismic sensor 114 in the soil, wherein each node 110 may comprise a stake 116 that is alone buried into the soil.

Stake 116 is mainly used for ensuring a good coupling of the node with the soil, but also helps with aligning the sensing axis of the seismic sensor with the vertical (or gravity) and maintaining this alignment during the seismic survey. In this regard, seismic sensors 114 have a natural “sensing” axis 202 (see FIG. 2), that needs to be positioned as close to a vertical axis 204 as possible. A tilt angle 206 between the sensing axis 202 and the vertical axis 204 can be allowed to be up to 20 degrees before degrading the measurement. If the tilt angle 206 goes above 30 degrees, no acquisition can be made with sensor 114. Thus, correctly positioning the node in the field is important for the existing seismic nodes.

No matter which of the above approach is taken, a large amount of time is still wasted on deploying and retrieving the nodes as they need to be correctly positioned in the field. Thus, there is a need for a new node and/or method for reducing the time associated with deploying and retrieving the nodes.

### BRIEF SUMMARY OF THE INVENTION

Deploying and retrieving nodes and/or sensors for seismic data acquisition (or other data) may be performed with a spherical node that self-adjusts its sensor's sensing axis relative to the vertical so that a tilt angle is reduced to not negatively impact the recording of the seismic data. This can be achieved with an inner frame that holds the sensor and other electronics, and the inner frame is placed inside a spherical outer shell, in contact with a support mechanism, so that the inner frame freely rotates relative to the spherical outer shell due to the support mechanism.

According to an embodiment, a sensing node for sensing a parameter when deployed on the ground includes an outer shell having a spherical internal cavity, an inner frame configured to hold a sensor and to fully fit inside the spherical internal cavity, and a support mechanism provided between the outer shell and the inner frame and configured to allow the inner frame to freely rotate relative to the outer shell and also configured to prevent the inner frame from directly touching the outer shell when dropped on the ground.

According to another embodiment, there is a sensing node for sensing a parameter when dropped on the ground, and the sensing node includes an outer shell having a spherical internal cavity, an inner frame configured to hold a sensor and to fully fit inside the internal cavity, and plural balls provided between the outer shell and the inner frame and configured to allow the inner frame to freely rotate relative to the outer shell and also configured to prevent the inner frame from directly touching the outer shell when dropped on the ground.

According to yet another embodiment, there is a method for deploying a sensing node on the ground for a survey, and the method includes dropping the sensing node on ground, from a delivery vehicle, the sensing node including an outer shell having a spherical internal cavity, aligning an inner frame, which is configured to hold a seismic sensor and to fully fit inside the internal cavity, with a gravity by allowing the inner frame to freely rotate relative to the outer shell due to a support mechanism provided between the outer shell and the inner frame, and recording seismic data with the seismic sensor. The support mechanism prevents the inner frame from directly touching the outer shell when dropped on the ground.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of a conventional land seismic surveying system;

FIG. 2 illustrates a tilt angle of a seismic sensor relative to gravity;

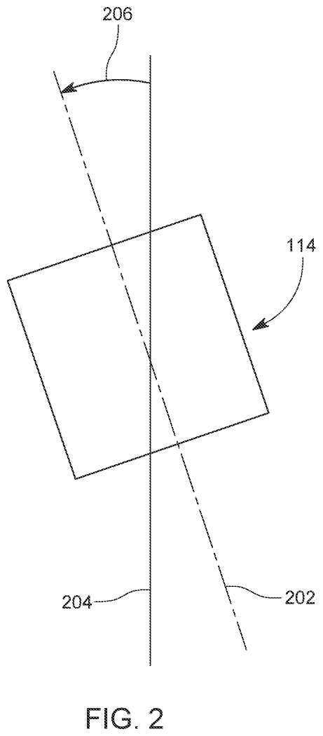

FIG. 3 illustrates an existing self-aligning node that uses a liquid for supporting an inner container relative to an outer container;

FIG. 4 is an overview of a sensing node that has a self-orienting capability to align a sensing axis with the gravity;

FIG. 5 shows a partial view of the sensing node of FIG. 4;

FIG. 6 shows an exploded view of an inner frame of the sensing node of FIG. 4.

FIG. 7 shows a partial view of one half of the inner frame of the sensing node of FIG. 4;

FIG. 8 schematically illustrates the location of plural balls making up a support mechanism of the sensing node of FIG. 4;

FIG. 9 schematically illustrates the location of some balls of the support mechanism relative to a center of the sensing node;

FIG. 10 schematically illustrates the two halves of the inner frame being attached to each other;

FIG. 11 schematically illustrates two sensing nodes being stacked on top of each other due to the particular shape of the outer shell; and

FIG. 12 is a flow chart of a method for dropping seismic nodes, with no regard for their orientation, on the ground.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a seismic node used for land seismic acquisition, the node having a spherical shell that holds inside an inner frame and the inner frame freely rotates relative to the spherical shell due to a support mechanism that includes five supporting balls. However, the embodiments to be discussed next are not limited to the support mechanism having five supporting balls, but may be used with more or less supporting balls. Further, while these embodiments are discussed with regard to the seismic node being deployed on a dry land surface, one skilled in the art would be able to utilize the embodiments discussed herein to adjust/modify the nodes to work in a marine environment (ocean bottom nodes) and/or underground. Further, the following embodiments are discussed, for practicality, with regard to a seismic sensing node. However, the teachings in these embodiments equally apply to any sensing, not only seismic sensing.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a self-orienting sensing node includes a spherical outer shell and an inner frame, which is fully located within the outer spherical shell. The term “spherical” when used to characterize the “outer shell” in this document refers to an inner surface, not to the outer surface, of the outer shell. While the outer surface of the spherical outer shell may also be spherical, this is not a requirement of the sensing node. A support mechanism is placed between the inner frame and the spherical outer shell to ensure that the inner frame freely rotates relative to the spherical outer shell. In one application, the inner frame is shaped to have a spherical shape, with a radius smaller than a radius of the inner surface of the spherical outer shell. The inner frame is configured to hold all the electronics of the sensing node and a power source. The power source is placed in the inner frame so that it biases the inner frame to always position in the same position relative to the gravity, no matter the orientation of the spherical outer shell. The spherical outer shell is shaped to have its internal surface spherical. The external surface of the spherical outer shell may be spherical or not. The spherical outer shell is configured to seal its interior from the ambient, so that no impurity comes into contact with the inner frame. The inner frame is fully independent of the spherical outer shell, i.e., it can freely rotate inside the spherical outer shell. In one application, there are no wires leaving the inner frame, i.e., no wires connecting the inner frame to the spherical outer shell. In one application, a ball supporting mechanism (or similar or equivalent mechanism) is the only mechanical connection between the inner frame and the outer shell. For maximizing use of an inner cavity of the spherical outer shell, in one application, the outer surface of the inner frame is spherical, and the inner surface of the spherical outer shell is also spherical. In this application, a radial distance between the two surfaces is minimized, for example, equal to or less than 1 mm. Other numbers may be used. Because of the full independence of the inner frame relative to the spherical outer shell, the data acquired by the seismic sensor, which is provided inside the inner frame, may be communicated outside the outer shell through a wireless method (e.g., using a transceiver). Details of the sensing node are provided after a brief review of an existing gimbaled seismic node.

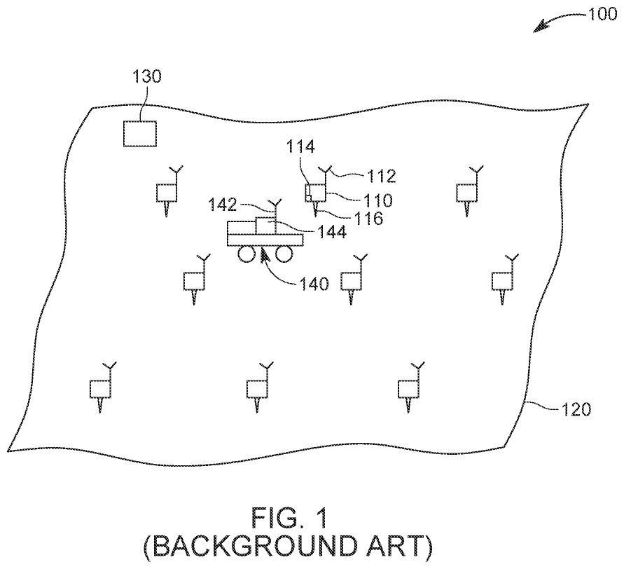

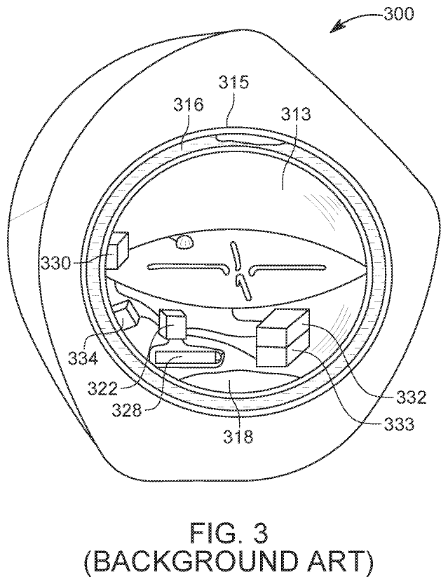

An example of a node with a self-orienting double housing is, for example, shown in FIG. 3, which corresponds to FIG. 1 in [1], for a liquid-based interfacing means for supporting relative movement between the two portions of the housing. More specifically, FIG. 3 shows a node 300 having an inner container 313 located within an outer container 315. The inner container 313 holds a control module 322, battery 328, sensor 330, transmitter 332, receiver 333, and a switch 334. The inner container 313 is separated by the outer container 315 by a liquid 316. A weight 318 is provided inside the inner container 313 to bias the inner container to orient itself relative to the gravity.

However, this device is problematic for a couple of reasons. The external surface of the inner container 313 needs to be impermeable to the liquid 316 or otherwise the electronics will be damaged by the liquid. This is not an easy task when the node is dropped on the ground. In addition, when the node is dropped from the back of a truck, while being distributed in the field, the inner container is likely to directly hit the outer container as the liquid moves around, which might damage the integrity of the inner container, and thus, its electronics. Further, if any component needs to be replaced inside the inner container, for example, the battery, it would be very difficult and time consuming to disassemble the node to reach the battery. Furthermore, the assembly process for such a node is difficult, in order to fill the space between the two containers 313 and 315 with the liquid 316.

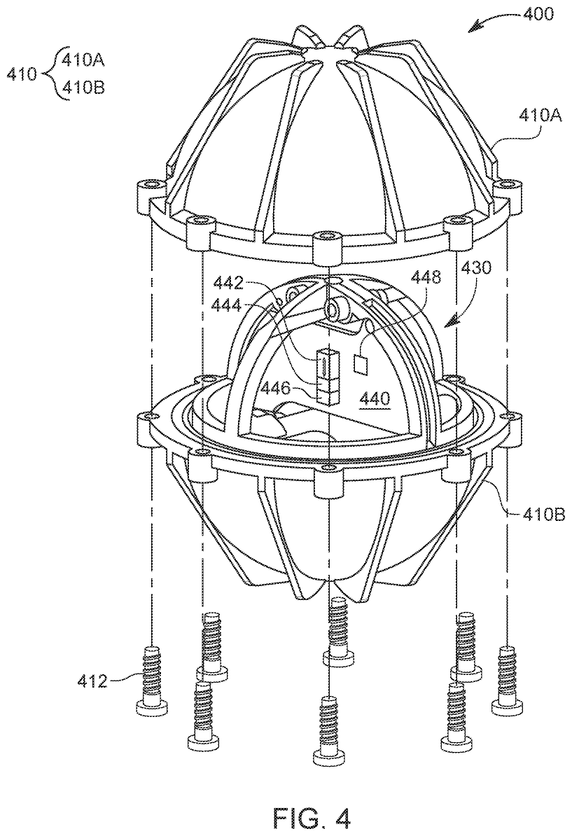

A node 400 now discussed with regard to the figures overcome some of these problems and achieves the orientation of the sensor with the gravity. More specifically, as shown in FIG. 4, node 400 has a spherical outer shell 410 and an inner frame 430, that fully fits inside an inner chamber defined by the spherical outer shell 410. In this embodiment, the spherical outer shell 410 is formed of two half shells 410A and 410B, which are configured to attach to each other with screws 412. An outer surface of the two half shells may be spherical or not. However, the inner surface of the inner chamber is spherical. The inner frame 430 supports a printed circuit board (PCB or similar substrate for holding electronics) 440 including a seismic sensor 442, a processor 444, and a storage device 446. Other electronic elements may be present, for example, a transceiver 448. The transceiver may generate a radio frequency link between the node 400 and the harvester to exchange data. The radio frequency link may be implemented as a WiFi connection, capacitive transmission, ultrasonic communication, high bit rate near field communication, etc.

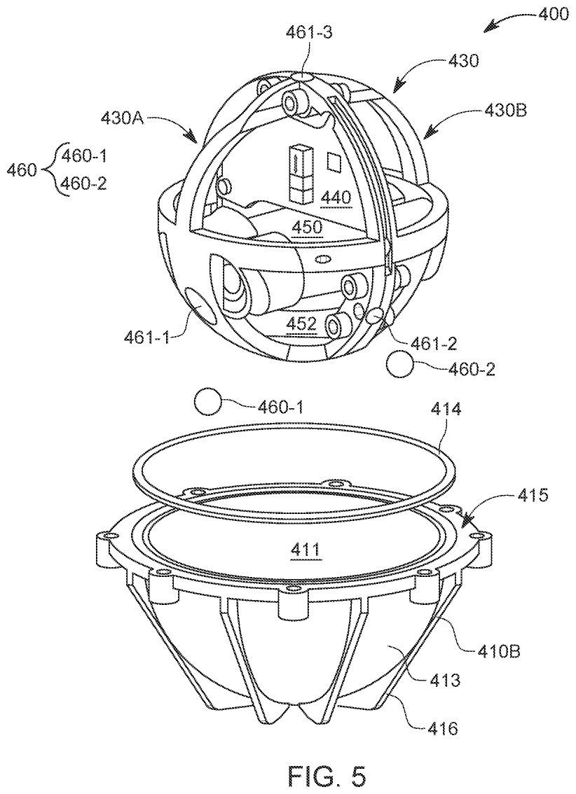

FIG. 5 shows the node 400 with the inner frame 430 removed from inside the spherical outer shell 410, and the top half shell 410A being omitted. An o-ring 414 is shown in the figure and is configured to fit in a channel 415 formed in a top edge of the bottom half shell 410B, for preventing impurities from outside the node entering into the inner cavity 411 when the other half shell is attached. The inner cavity 411 is formed to have a spherical shape when the two half shells 410A and 410B are placed together. Although the outer surface 413 of the half shells may also be shaped to be spherical, in the embodiment illustrated in FIGS. 4 and 5, the outer surface 413 is modified to have ribs 416, to prevent the node from rolling when dropped on the ground. The ribs may take any shape and/or form as long they extend from the outer surface 413, as shown in FIGS. 4 and 5.

FIG. 5 shows two balls 460-1 and 460-2 that form the support mechanism 460, which is configured to hold the inner frame 430 substantially concentric to the spherical outer shell 410. The support mechanism 460 may include additional balls, for example, 2 or more balls. In this embodiment, the support mechanism 460 includes a total of 5 balls. The location of the balls is discussed later. The balls are made in this embodiment of a light material, so that the shock experienced by them during the dropping of the node does not damage the spherical outer shell or the inner frame. For example, the balls, the inner frame, and the spherical outer shell may be made of plastic. Because the friction between the balls and the spherical outer shell and the inner frame needs to be as small as possible, the balls may be made of, or covered with Teflon material. FIG. 5 further shows the PCB 440, a battery 450, and a counterweight 452, all of each are discussed later in more detail.

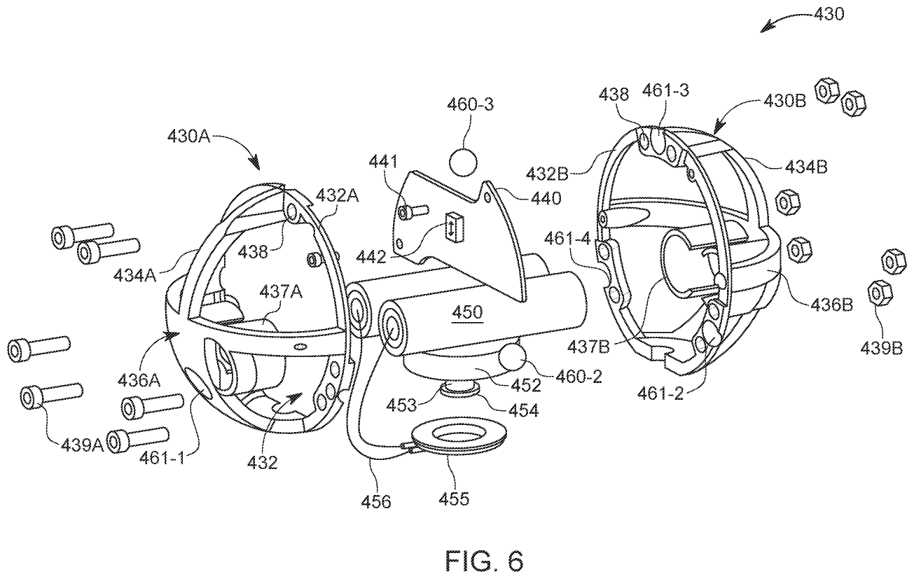

The inner frame 430 is made in this embodiment of two halves 430A and 430B, as better illustrated in FIG. 6. The two halves 430A and 430B are shaped as spheres, but their walls do not extend to fully cover a sphere. Plural empty regions are present in the walls. In this embodiment, each of the two halves has a circumferential edge 432A, 432B, respectively, from which plural spokes 434A, 434B extend away and meet at a common vertex area 436A, 436B. The plural spokes are arched so that the overall shape of the two halves resembles half spheres, respectively. The two halves 430A and 430B have corresponding holes 438 formed on their edges 432A, 432B, so that screw bolts 439A and nuts 439B may be used to connect the two halves to each other, to form the inner frame 430. The PCB 440 is attached to only one of the two halves with corresponding screws 441.

The vertex areas 436A and 436B are configured with receiving brackets 437A and 437B, respectively. Brackets 437A and 437B are sized to snugly receive the battery 450 (may be one or more elements forming the battery), for supplying power to the electronics on the PCB 440. In this embodiment, the PCB 440 is located in a vertical plane and the battery 450 in a horizontal plane, when the inner frame is aligned relative to the gravity. A counterweight 452 is configured to be sandwiched between the two halves 430A and 430B so that no bolts or screws or glue is used to hold it. The same is true for the battery. The counterweight 452 is shaped to have a neck 453 that ends with an extended rim 454 so that a coil 455 can slide over the rim 454 and fit onto the neck 453. The coil 455 may be connected with corresponding wires 456 to the battery 450 for recharging it. Battery 450 may be any known battery. The coil 455 is used for inductive charging of the battery, i.e., a mating coil from an external charger (not shown) may be placed next to coil 455, for transferring power from the external charger to the battery 450.

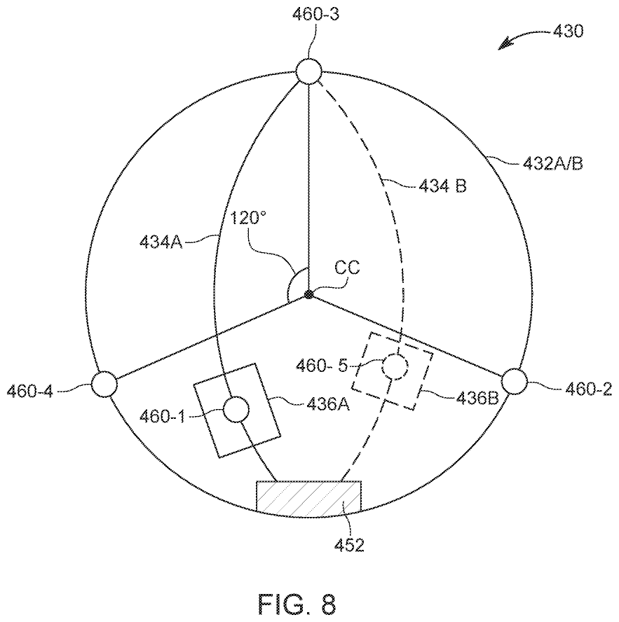

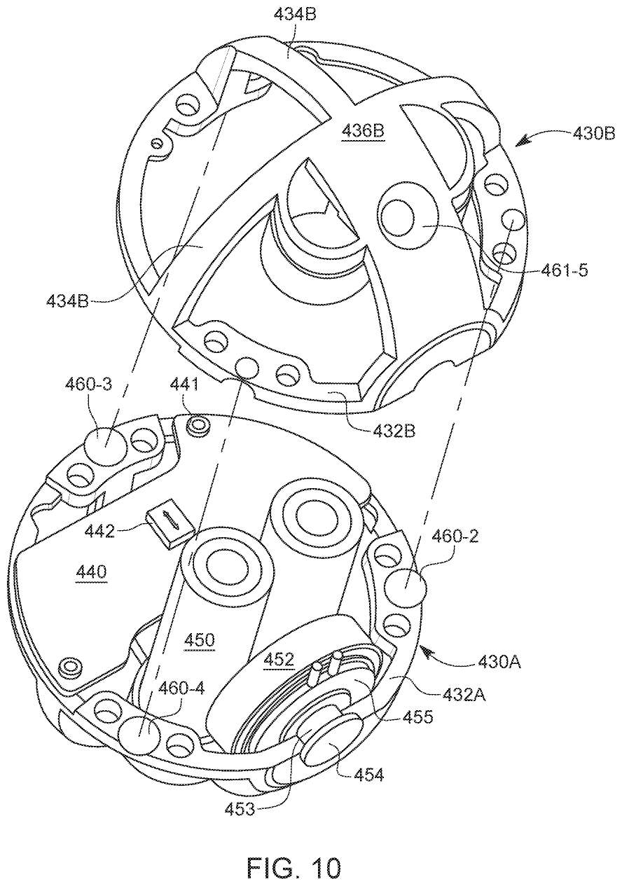

FIG. 6 also shows 4 receiving cavities 461-1 to 461-4 for receiving the support balls 460-1 to 460-4. The fifth receiving cavity 460-5 and the first ball 460-5 are not visible in this figure as they are located behind the second half 430B. However, they are visible in FIGS. 8 and 10. For the embodiment shown in FIGS. 4 to 6, the support mechanism 460 includes only five receiving cavities and five balls. Three of the receiving cavities, 461-2, 461-3, and 461-4 are defined by the edges 432A and 432B, the fourth cavity 461-1 is located on the vertex area 436A and the fifth receiving cavity 461-5 is located on the other vertex area 436B. This means that the receiving cavities 461-2, 461-3, and 461-4 are located on the circumference of the inner frame 430 as the two edges 432A and 432B, when connected to each other, form the circumference of the inner frame.

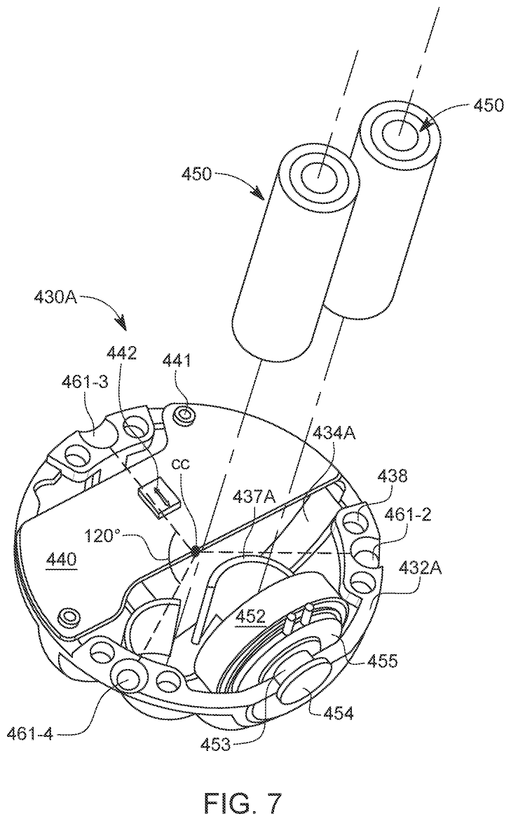

In one embodiment, the receiving cavities 461-2, 461-3, and 461-4 are sized to cover more than half of the volume of the corresponding balls 460-2, 460-3, and 460-4 (called herein the “circumferential balls”), respectively, when the two halves 430A and 430B are attached to each other. This means that when the two halves are connected to each other, the circumferential balls 460-2, 460-3, and 460-4 are trapped inside the corresponding receiving cavities 461-2, 461-3, and 461-4. Differently, the other two balls are not trapped inside their corresponding receiving cavities. Also, the receiving cavities 461-2, 461-3, and 461-4 are defined by both halves 430A and 430B, while each of the other two cavities are entirely defined by a corresponding half. The three circumferential balls 460-2, 460-3, and 460-4 located on the circumference of the inner frame 430 are symmetrically located along the circumference, i.e., they make a 120° angle with each other relative to the center CC of the node 400, as illustrated in FIGS. 7 and 8 (FIG. 7 shows the receiving cavities and FIG. 8 shows the balls). In one application, the two receiving cavities 461-2 and 461-4, which are positioned at the bottom of the inner frame 430 (when the inner frame is aligned, ball 460-3 sits at the top vertex of the frame and balls 460-2 and 460-4 sit closer to the bottom vertex), due to the bias imposed by the counterweight 452, which is schematically illustrated in FIGS. 7 and 8, are either at the same level as the battery 450, or at a lower level (i.e., the battery and the two lowest balls 460-2 and 460-4 may be distributed in the same horizontal plane, or the battery is distributed in a horizontal plane located above a horizontal plane defined by the two lowest balls 460-2 and 460-4.

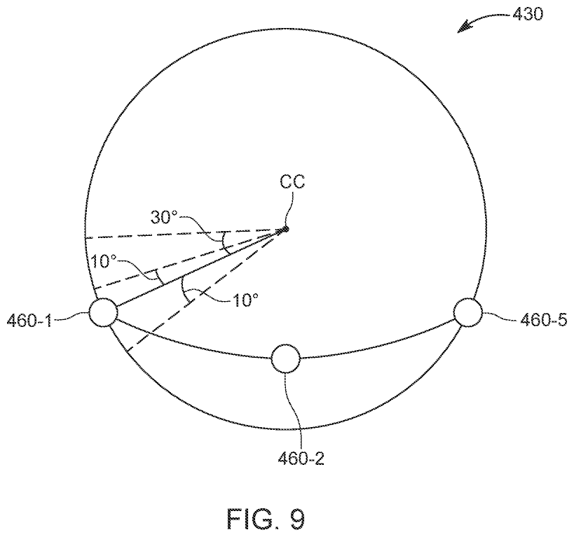

The two vertex balls 460-1 and 460-5 (see FIG. 5) are distributed in a horizontal plane, perpendicular to the plane formed by the circumferential balls 460-2, 460-3, and 460-4. In one application, the horizontal plane of the vertex balls 460-1 and 460-5 coincides with a horizontal plane in which the circumferential balls 460-2 and 460-4 are located. However, the horizontal plane of the vertex balls may be located up to 10 degrees up or down relative to the horizontal plane of the circumferential balls, as schematically illustrated in the inner frame cross-section in FIG. 9.

FIG. 10 shows the first half 430A of the inner frame 430 having the battery 450, counterweight 452, and PCB 440 mounted therein, and the second half 430B being ready to be attached to the first half. The figure shows the neck 453 of the counterweight 452 going to be sandwiched between the two halves 430A and 430B of the inner frame 430, and the coil 455 being fully located within the inner frame 430, on the neck 453, above the rim 454. The PCB 440 is shown having only the sensor 442, as the other electronics are omitted for simplicity.

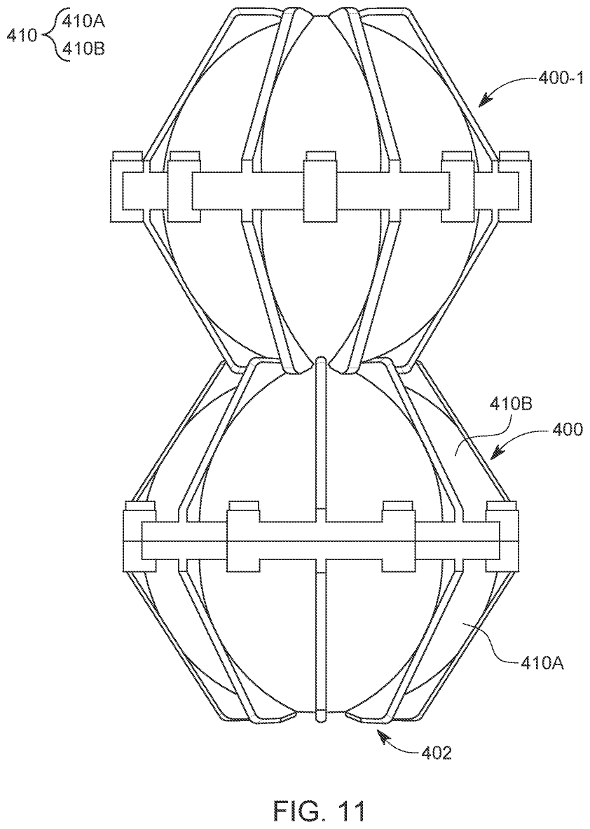

FIG. 11 shows the fully assembled node 400, with the inner frame 430 (not visible) being sealed inside the inner cavity 411 of the spherical outer shell 410, and the top and bottom of the spherical outer shell 410 being shaped as flat surfaces 402 so that another node 400-1 can be stored/stacked in top of the node 400.

FIGS. 4 to 10 show the support mechanism 460 including 5 support balls 460-1 to 460-5, 3 disposed on a vertical circumference of the inner frame 430, at an interface between the two halves of the inner frame, a fourth one located close to a vertex area of one half of the inner frame, and a fifth ball located close to a vertex area of the other half. However, one skill in the art would understand that these 5 balls may be arranged differently as long as they support the inner frame relative to the spherical outer shell so that the two elements do not directly touch each other. In one embodiment, only 4 (non co-planar) balls may be used, for example, three balls arranged in a given plane, that is parallel to the battery plane (either above, below or at the same level as the battery plane) and a fourth ball at the top vertex of the inner frame. In one embodiment, more than 5 (not on the same plane) balls may be used. In yet another embodiment, the lowest balls may be arranged to be at the same level as the battery plane, or even lower than the battery plane, or even higher than the battery plane.

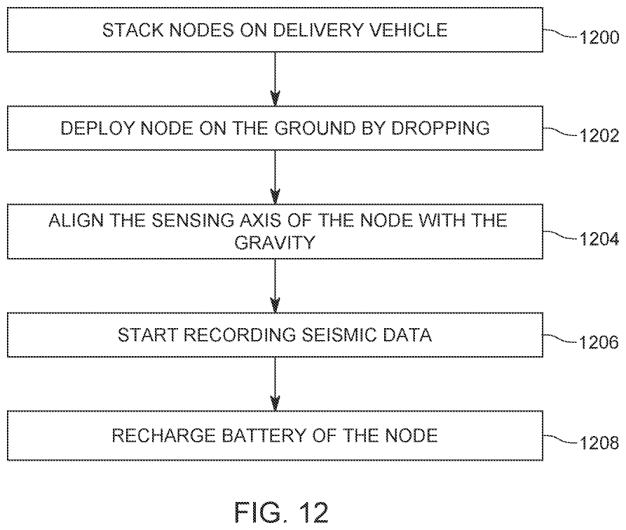

A method for deploying the self-aligning node and collecting seismic data with a seismic sensor located inside the node is now discussed with regard to FIG. 12. The method starts in optional step 1200, where the assembled nodes 400 are stacked on top of each other, as illustrated in FIG. 11. The nodes may be loaded in a truck or any other delivery vehicle, for example, a flying device, a marine vessel (if the node 400 is an ocean bottom node), etc. The delivery vehicle then covers the area of interest and deploys 1202 nodes 400 by dropping them from the truck directly onto the ground. After landing, the nodes achieve good contact with the soil due to their shape, and experience minimal rolling due to the ribs 416. Note that no spikes are used to attach the nodes to the ground. Also, there is no manual or mechanical intervention from the operator of the delivery vehicle for orienting the nodes. The sensor 442 together with its PCB 440 start rotating (aligning) in step 1204, due to the bias applied by the counterweight 452 and battery 450, so that the sensing direction of the sensor automatically and autonomously aligns with the gravity due to the freedom provided by the support mechanism 460. In step 1206, when an external command is received by the transceiver 448 or a timer in the processor 444 is triggered, the sensor 442 starts recording the seismic signals. In optional step 1208, when the node is either in a recovery facility or still on the ground, an inductive charging device is placed next to the coil 455 for recharging the battery 450.

The structures discussed in the above embodiments are configured to achieve the self-orienting of the inner frame 430 relative to a random landing position of the spherical outer shell 410 so that the sensing axis of the sensor 442 is automatically aligned with the gravity. The (seismic) sensor 442 may be embodied as a micro-electromechanical (MEMS) device. However, in some embodiments, the sensor may be embedded in a chip or chip set. In other words, the sensor may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The sensor may therefore, in some cases, be configured to implement an embodiment of the present invention on a single chip or as a single “system on a chip.” As such, in some cases, a chip or chipset may constitute means for performing one or more operations for providing the functionalities described herein.

The electronics 444/446/448 may be embodied in a number of different ways. For example, the electronics may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the electronics may include one or more processing cores configured to perform independently. A multi-core processor may enable multiprocessing within a single physical package. Additionally, or alternatively, the processor may include one or more processors configured in tandem via the bus to enable independent execution of instructions, pipelining and/or multithreading.

In an example embodiment, the processor 444 may be configured to execute instructions stored in the memory device 446 or otherwise accessible to the processor via transceiver 448. Alternatively, or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The disclosed embodiments provide a (seismic) sensing node that collects data (e.g., seismic data) when its sensor has the sensing axis aligned with the gravity, and the node can be dropped without regard to its landing position, as an inner frame is automatically oriented to achieve the alignment of the sensing axis with the gravity. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

[1] U.S. Pat. No. 6,642,906;

What is claimed is:

1. A sensing node for sensing a parameter when dropped on the ground, the sensing node comprising:
an outer shell having a spherical internal cavity;
an inner frame configured to hold a sensor and to fully fit inside the spherical internal cavity; and
a support mechanism provided between the outer shell and the inner frame and configured to allow the inner frame to freely rotate relative to the outer shell and also configured to prevent the inner frame from directly touching the outer shell when dropped on the ground.

2. The sensing node of claim 1, wherein the support mechanism includes plural balls that directly contact each of the outer housing and the inner frame.

3. The sensing node of claim 1, wherein the support mechanism consists of first to fifth balls.

4. The sensing node of claim 3, wherein the first to third balls are located in corresponding receiving cavities, symmetrically distributed along a circumference of the inner frame.

5. The sensing node of claim 4, wherein the fourth ball is located on a first half of the inner frame and the fifth ball is located on a second half of the inner frame, opposite to the fourth ball.

6. The sensing node of claim 5, wherein the first ball is located at a top of the inner frame and the second to fifth balls are located in a same horizontal plane, below an equator of the inner frame.

7. The sensing node of claim 6, further comprising:
a battery configured to be hold by the inner frame.

8. The sensing node of claim 4, wherein the circumference is defined by an interface between first and second mating halves of the inner frame.

9. The sensing node of claim 1, further comprising:
a printed circuit board holding the sensor and attached to the inner frame; and
a battery attached to the inner frame and fully located within the inner frame.

10. The sensing node of claim 9, further comprising:
a counterweight sandwiched between first and second halves of the inner frame; and
a coil attached to a neck of the counterweight,
wherein the coil is electrically connected to the battery for inductive charging.

11. The sensing node of claim 10, wherein the coil is fully located within the inner frame.

12. The sensing node of claim 1, wherein the inner frame is formed of two halves, each half comprising:
a circumferential edge;
plural spokes attached with corresponding first ends to the circumferential edge; and
a vertex area connected to corresponding second ends of the plural spokes.

13. The sensing node of claim 12, wherein the circumferential edge has receiving cavities for holding balls of the support mechanism.

14. The sensing node of claim 13, wherein the vertex area of each half of the inner frame has a receiving cavity for hosting a corresponding additional ball of the support mechanism.

15. The sensing node of claim 1, further comprising:
a battery; and
a counterweight,
wherein each of the battery and the counterweight is attached to the inner frame with no bolts or screws or glue.

16. The sensing node of claim 1, wherein the outer shell is made of two half shells, each having exterior ribs.

17. The sensing node of claim 1, wherein the sensor is a seismic sensor configured to collect seismic data.

18. The sensing node of claim 1, wherein an outer surface of the inner frame is spherical.

19. A sensing node for sensing a parameter when dropped on the ground, the sensing node comprising:
an outer shell having a spherical internal cavity;
an inner frame configured to hold a sensor and to fully fit inside the internal cavity; and
plural balls provided between the outer shell and the inner frame and configured to allow the inner frame to freely rotate relative to the outer shell and also configured to prevent the inner frame from directly touching the outer shell when dropped on the ground.

20. A method for deploying a sensing node on the ground for a survey, the method comprising:
dropping the sensing node on ground, from a delivery vehicle, the sensing node including an outer shell having a spherical internal cavity;
aligning an inner frame, which is configured to hold a seismic sensor and to fully fit inside the internal cavity, with a gravity by allowing the inner frame to freely rotate relative to the outer shell due to a support mechanism provided between the outer shell and the inner frame; and
recording seismic data with the seismic sensor,
wherein the support mechanism prevents the inner frame from directly touching the outer shell when dropped on the ground.
